(19) United States
(12) Patent Application Publication
(10) Pub. No.: US 2008/0225527 A1
(43) Pub. Date: Sep. 18, 2008

(54) Illumination Unit

(75) Inventors: Holger Monch, Vaals (NL); Peter Claus, Keerbergen (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,707

(22) PCT Filed: Jul. 12, 2006
(86) PCT No.: PCT/IB2006/052366

§ 371 Date: Jan. 15, 2008

(30) Foreign Application Priority Data
Jul. 20, 2005 (EP) 05106624.9

(51) Int. Cl. F21V 7/00; F21V 7/08

(52) U.S. Cl. 362/296

(57) ABSTRACT

The invention relates to an illumination unit that comprises at least a reflector (3) and a UHP lamp (2), which UHP lamp has at least one burner (20) having a discharge chamber (21), wherein, when the lamp is operating, at least part of the IR light emitted from the burner material of the UHP lamp (2) makes its way back to at least a part of the burner (20) by reflection from the reflector (3) and/or from another component of the illumination unit (1).

The invention relates to an illumination unit that comprises at least a reflector and a UHP lamp, which lamp has at least one burner having a discharge chamber, at least part of the IR light emitted from the burner material of the UHP lamp making its way back to at least part of the burner when the lamp is operating.

An illumination unit that comprises at least a reflector and a UHP lamp is known and is used for different applications in which the primary purpose of the illumination unit is to supply visible light.

Because of their optical properties, high intensity discharge (HID) lamps, and in particular ultra high performance (UHP) lamps, are used as preferred lamps for, among other things, projection purposes. For the purposes of the invention, the designation UHP lamp (a Philips designation) also covers other lamps of the UHP type.

A light source which is as nearly as possible a point source is required for certain applications. What is also normally desirable is a luminous intensity which is as high as possible with as natural as possible a spectral composition for the light.

At the present time these properties can best be achieved with UHP lamps. However, if these lamps are to be developed, there are two essential requirements which both have to be met at the same time:

On the one hand, the maximum temperature at the inner surface of the discharge chamber must not be sufficiently high for devitrification of the envelope of the lamp, which is generally made of quartz glass, to take place. This may be a problem because the region above the arc is particularly severely heated as a result of the pronounced convection within the discharge chamber of the lamp. Hence there is a non-uniform temperature distribution in the discharge chamber.

On the other hand, the coldest point on the inner surface of the discharge chamber still has to be at a sufficiently high temperature (approx. 1200 K) for the mercury not to deposit at it but to remain, overall, in the vaporized state to a sufficient degree. Particularly in small and highly loaded discharge lamps, the maximum and minimum temperatures are difficult to reconcile and in certain applications may cause problems for the setting of optimum lamp operation with, at the same time, an adequate life for the lamp.

Commercially available UHP lamps, when operated at their nominal power, always conform to the requisite temperature ranges of approximately 1200 K to 1400 K.

Also, the design of the burner is always optimized for a given nominal power, such as 100 W for example.

It is however desirable for the operating range that is possible to be extended, e.g. to allow the lamp to be dimmable or to upgrade a type of lamp, and in particular to allow a burner to be used for an electrical power different than the nominal power for which it was originally intended for applications in which the lumen output required is lower.

In dimming, i.e. when the actual electrical power is reduced to below the nominal power, the temperature of the coldest point must not drop below the minimum temperature. In this way tight limits are set for the dimmability of a given lamp that is optimized for a given nominal power.

It is not possible for the lamp to be operated outside this limiting range, at 75% of its nominal power for example, without a significant adverse effect on its life, but in practice it is in fact desirable for it to be so operated. There is also a considerable demand for lamps of higher powers.

In the endeavor to design lamps of this kind in the optimum way, the problem is encountered that although additional heat can be dissipated by enlarging the surface area of the envelope of the lamp this results in a fall in the lower critical temperature. Hence the desired pressure in the lamp is no longer achieved.

Known from DE 101 00 724 A1 is a high intensity discharge lamp having cooling means. This lamp can be operated at a raised power in this way because the increase in temperature in the interior of the lamp generates an increased gas pressure. The cooling means is so arranged and sized in this case that devitrification and condensation of the filling gas are substantially stopped if the power is raised. Because of the way in which it operates, the cooling described produces comparatively high heat dissipation.

In many applications in the lighting field where, for functional reasons, it is primarily visible light that is required, attempts are made to divert the radiant light that is not wanted for this purpose, such as IR light for example, to a different (secondary) use. For example, to increase the efficiency of a gas discharge lamp various solutions are known that have filters or reflectors that allow visible light to pass through but not unwanted radiant light and in particularly IR light. What such reflectors do is for example to reflect the unwanted radiant light back into the region of the burner in order to reduce, at the burner, the electrical power that is required to ensure a given minimum temperature.

It is not possible for this solution to be applied to an illumination unit that comprises at least a reflector and a UHP lamp. Nor can it be applied to an illumination unit of this kind having a UHP lamp that carries on the burner a coating that partly covers the burner and reflects visible radiation back into the burner, as is known from US 2005/0024880 A1 for example.

It is therefore an object of the invention to provide an illumination unit of the kind specified in the opening paragraph wherein it is ensured that the temperature of the coldest point does not fall below a limiting value even though either the lamp is operated at reduced power (is dimmed) or the heat dissipation is increased by means of an enlarged surface area. The intention is also for the illumination unit to be capable of being manufactured effectively in the context of industrial mass production.

The object of the invention is achieved by virtue of the features of claim 1.

It is essential to the invention that at least part of the IR light emitted from the burner material of the UHP lamp makes its way back to at least a part of the burner by reflection from the reflector and/or from another component of the illumination unit. The IR light that makes its way to the burner, in particular IR light of a wavelength >3 μm, is used for the local heating of the burner material of the UHP lamp, thus enabling condensation of mercury to be effectively prevented while leaving the design of the burner unchanged and the power of the lamp the same.

The dependent claims relate to advantageous further embodiments of the invention.

It is preferable for there to be arranged on the burner a coating that partly covers the burner and reflects visible radiant light back into the burner. The solution according to the invention is particularly advantageous when use is made of UHP lamps that have a coating that acts as a reflex reflector in accordance with the teaching of US 2005/0024880 A1. In the connection that is described here, the principal advantage is that hardly any usable light emerges from the coated part of the burner and the corresponding part of the reflector therefore does not have to be optimized for the collection of light but can be used for other purposes, e.g. the reflex reflection of the thermal radiation.

It is also preferable for at least part of the reflector to be so formed that IR light that impinges thereon can be reflected in particular, or only, to the coldest part of the burner. This makes it possible, when the burner is fitted in a horizontal position, for in particular, or only, the bottom part of the burner to be heated. It is thus possible to act on the difference in temperature between the coldest and hottest points within the discharge chamber.

It is also preferable for the reflector to be of an elliptical and a spherical shape, the spherical part of the reflector being so arranged that the IR light that makes its way through the coating can be reflected at the said part. This special arrangement of the reflector in at least two parts allows the reflex reflection of the IR light to be achieved in a technical simple way.

It is also preferable for the burner to be enclosed by an evacuated outer envelope that is sealed to be airtight. It is particularly advantageous in this case if the light exit plate is at least partly non-transparent to IR light or carries a coating that is non-transparent in this way.

The object of the invention is also achieved by a projection system having at least one illumination unit according to the invention.

These and other aspects of the invention are apparent from and will be elucidated with reference to the embodiments described hereinafter.

In the drawings:

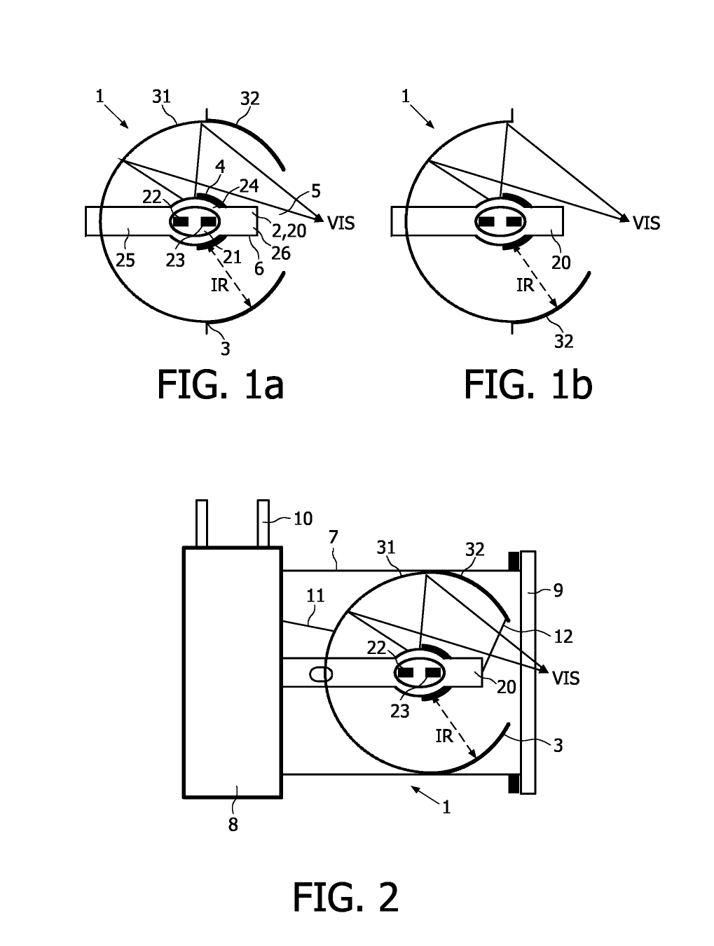

FIG. 1 is a schematic view in section of an illumination unit according to the invention.

FIG. 2 is a schematic view in section of an illumination unit according to the invention having an outer envelope.

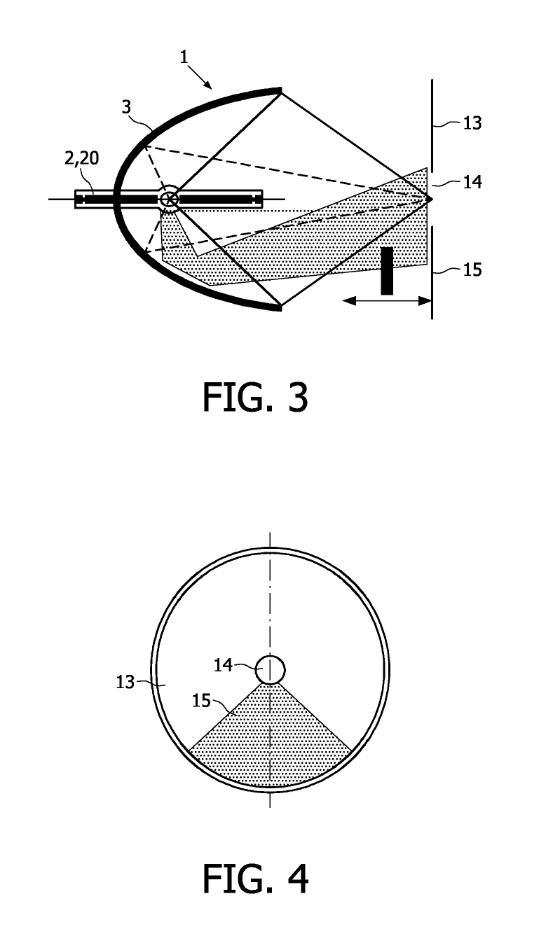

FIG. 3 is a schematic view in section of an illumination unit according to the invention having an elliptical reflector and a diaphragm.

FIG. 4 is a schematic view from the front of a diaphragm as shown in FIG. 3.

An illumination unit 1 according to the invention is shown in FIG. 1. This has, as a light source, a UHP lamp 2 that is arranged and fastened in place in the usual way in a reflector 3.

The reflector 3 is in two parts, namely an elliptical part 31 (the main reflector) and a spherical part 32, the spherical part 32 of the reflector 3 being so arranged that the IR light that passes through the coating 4 can be reflected therefrom. The spherical part 32 has, as shown in FIG. 1a, an approximately cylindrical exit opening for light. The reflection takes place in such a way that the IR light is mainly reflected back onto the spheroidal part 24 of the burner 20. The material of which the reflector 3 is composed is aluminum, which reflects IR light effectively. The spherical part 32 of the reflector 3 does not need to be produced to a high standard of exactness. Even if it is of a simple form it will perform its primary function, namely to reflect the IR light back towards the spheroidal part 24 of the burner 20, which has a diameter of approximately 9 mm. Reflex reflection of the IR light back into the gap (approximately 1 mm) between the two electrodes 22, 23 would be many times more complicated and costly.

The UHP lamp 2 has a burner 20 having a discharge chamber 21 in which are situated a normal discharge gas and an electrode arrangement. The electrode arrangement is formed by the two electrodes 22, 23, between whose tips the gas discharge takes place in a known manner. The burner 20 and the main reflector 3 are so arranged in relation to one another that the location of the light source proper, namely the region between the two electrodes 22, 23, is situated substantially at the focal point of the main reflector 31.

On the spheroidal part 24 of the burner 20 is situated a reflex reflector 4 in the form of a reflective layer. The reflex reflector 4 is a multi-layered interference filter that partly covers the burner 20, that reflects visible radiation back into the burner 20 and that allows IR light to pass through. In the multi-layered structure of the interference filter, layers having a higher refractive index alternate with layers having a lower refractive index. The refractive index of the particular layer is determined in particular by the material selected for the layer, with at least two dielectric materials that differ from one another in the relevant respect being present in the layered structure. Further details of, and possible layouts for, the layered structure and the materials selected for it can be found in, for example, US 2005/0024880 A1.

The surface of the spheroidal part 24 is shaped in such a way that the light emitted from the gas discharge that impinges on the reflex reflector 4 is reflected back through the gas discharge onto the main reflector 31. Under the teaching of US 2005/0024880A1, the reflex reflector 4 is of a size such that it covers not quite half of that region of the burner 20 that surrounds the gas discharge chamber.

The reflex reflection which has been described, effected by means of the spheroidal part 32 of the reflector 3, resulted, as shown by measurements made for the purpose, in the electrical power that has to be applied being reduced to approximately 80 W for the solution according to the invention when compared with an illumination unit (not having the means according to the invention) having a nominal power of 100 W.

To allow a further reduction to be made in the electrical power that has to be applied, the two cylindrical ends 25, 26 carry a layer 6 that reflects at least IR light, or in other words thermal radiation, and that is composed of, for example, metal (gold or silver) or zirconium oxide. This reflective layer 6 produces a further reduction in the electrical power that has to be applied to approximately 60 to 70 W.

Measurements in the laboratory have shown that when the illumination unit 1 according to the invention (as shown in FIG. 1) is arranged in an evacuated outer envelope (not shown in FIG. 1) that is sealed to be airtight, a further reduction in the electrical power that has to be applied to approximately 40 to 50 W is possible.

With the means according to the invention that have been described, it has thus been possible to provide an illumination unit that has a burner that is designed for a nominal power of 100 W yet can be operated at a very much reduced electrical power, such as 60 W for example, without any adverse effect on its normal life.

In FIG. 1b is shown, schematically, an alternative illumination unit 1 according to the invention that is of the same design except (relative to FIG. 1a) for the form taken by the spherical part 32. The spherical part 32 of the reflector 3 is so formed and arranged that IR light that makes its way through the coating 4 can be reflected at the said spherical part 32 and travels to the bottom part of the burner, which bottom part, when the burner is fitted in a horizontal position as shown here, is the coldest part of the burner.

A further embodiment of the illumination unit 1 according to the invention that has an outer envelope 7 is shown schematically in FIG. 2.

The construction and arrangement of the burner 20 and reflector 3 are basically similar to those shown in FIG. 1a but the burner 20 and reflector 3 are arranged in an outer envelope 7. The outer envelope 7 is cylindrical and is sealed off at one end with an airtight seal by the base 8 and at the other end, also with an airtight seal, by a light exit plate 9.

The light exit plate 9, which is in the form of a plate, is composed of, for example, borosilicate glass. The base 8 is produced from conventional ceramic materials. The electrical input means 10 are laterally mounted on the base 10, with one electrical connection being made via a wire 11 from the base 8 to the metal reflector 3, i.e. to its parts 31 and 32, and on, via the front wire 12, to the electrode 23. The other electrical connection is made from the electrical input means 10 via the base 8 to the electrode 22 and is not shown in FIG. 2.

In the outer envelope may be contained substances that are known per se and that prevent, or at least reduce, any oxidation of the metal components.

A further embodiment of the illumination unit 1 according to the invention, having an elliptical reflector 3 and a diaphragm 13, is shown schematically in FIG. 3 in a view from the side.

The reflector 3 is of a normal, elliptical, one-piece design. The material of which the reflector 3 is composed is aluminum, which reflects IR light effectively.

A UHP lamp 2 is horizontally arranged in the usual way in the reflector 3 on the optical axis. In the direction in which the light emerges from the illumination unit 1, a diaphragm 13 is arranged on the beam path and on the optical axis. This diaphragm 13 is so positioned, and has an aperture 14 that is of a size such, that visible light coming from the illumination unit can pass through the aperture 14 and at least part of the IR light having a wavelength >3 μm cannot. Applied to the diaphragm 13 is a layer 15 that reflects at least this IR light, which means that the IR light travels to the reflector 3 and from there to the region of the burner 21.

A different view (a view from the front) of a diaphragm 13 as shown in FIG. 3 is shown in FIG. 4. The disc-shaped diaphragm 13 has an aperture 14, with a layer 15 reflective of IR light being arranged below the aperture 14. This reflective layer 15 is a partial coating that covers a sector of the surface of the diaphragm 13. In the present case the sector extends through approximately 90° and is symmetrical to the vertical. With this arrangement, it is the bottom part of the burner 20 that is heated selectively, the amount of heat applied being able to be acted on by way of the size of the sector.

The invention is not limited to the two embodiments but also extends to further embodiments.

What is also covered for example is an illumination unit that has at least one UHP lamp and one one-piece reflector. This reflector may be both parabolic and also elliptical in shape, with a diaphragm or light exit plate being arranged on the beam path in the direction in which light emerges from the illumination unit. The latter items then act in a similar way to allow visible light to pass through and at least part of the IR light to be reflected back to the reflector. This reflex reflection for the purposes of the invention would take place in such a way that additional heating of the burner, and in particular of its bottom part, was ensured.

1. An illumination unit comprising at least a reflector (3) and a UHP lamp (2), which UHP lamp has at least one burner (20) having a discharge chamber (21), wherein, when the lamp is operating, at least part of the IR light emitted from the burner material of the UHP lamp (2) makes its way back to at least a part of the burner (20) by reflection from the reflector (3) and/or from another component of the illumination unit (1).

2. An illumination unit as claimed in claim 1, characterized in that there is arranged on the burner 20 a coating (4) that partly covers the burner (20) and reflects visible radiation back into the burner (20).

3. An illumination unit as claimed in claim 1, characterized in that at least part of the reflector (3) is so designed that the IR light that impinges thereon can be reflected, in particular towards the coldest part of the burner (20).

4. An illumination unit as claimed in claim 2, characterized in that the reflector (3) has an elliptical part (31) and a spherical part (32), the spherical part (32) of the reflector (3) being so arranged that the IR light that makes its way through the coating (4) can be reflected from the said spherical part (32).

5. An illumination unit as claimed in claim 4, characterized in that when the burner (20) is fitted in a horizontal position, in the reflector (3), the IR light can be reflected principally into the bottom half of the burner (20).

6. An illumination unit as claimed in claim 1, characterized in that at least a part of the burner (20), and in particular its cylindrical end (25, 26) that does not act as a light exit opening or as a location for the coating, has a coating (6) that is non-transparent to IR light or restricts IR light.

7. An illumination unit as claimed in claim 1, characterized in that the burner (20) is enclosed by an evacuated outer envelope (7) that is sealed to be airtight and that has a light exit plate (9) that is at least partly non-transparent to IR light.

8. An illumination unit as claimed in claim 7, characterized in that at least part of the light exit plate (9), which plate (9) is composed of glass, carries a coating that at least partly reflects IR and allows visible light in particular to pass.

9. An illumination unit as claimed in claim 1, characterized in that a part of the electrical input means is connected to the reflector.

10. A projection system that includes at least one illumination unit as claimed in claim 1.
